(19) United States
(12) Patent Application Publication
(10) Pub. No.: US 2011/0255816 A1
(43) Pub. Date: Oct. 20, 2011

(54) BEARING ELEMENT WITH POROUS ELEMENTS IN RING SEGMENTS

(75) Inventor: Ewald Foertschbeck, Uttenreuth (DE)

(73) Assignee: Paul Mueller GmbH & Co. KG Unternehmensbeteiligungen, Nuernberg (DE)

(21) Appl. No.: 12/998,905

(22) PCT Filed: Dec. 17, 2009
(86) PCT No.: PCT/DE2009/075078

§ 371 Date: Jun. 15, 2011

(30) Foreign Application Priority Data
Dec. 19, 2008 (EP) 08172379.3

(51) Int. Cl. F16C 33/66

(52) U.S. Cl. 384/469

(57) ABSTRACT

The invention relates to a bearing element with rolling bodies which are arranged in the peripheral direction between an inner ring and an outer ring disposed concentrically to the inner ring, particularly with a cage for holding the rolling bodies, the bearing element comprising porous elements along the peripheral direction in individual ring segments for receiving lubricant.

The invention relates to a bearing element having rolling bodies which are arranged in the circumferential direction between an inner ring and an outer ring which is arranged concentrically with respect to the inner ring.

Rotating machine parts generally move at a rotational speed with respect to the surroundings, to which they are fastened. In the case of high rotational speeds, the connection between the rotating machine parts and the surroundings is usually configured as an antifriction bearing of a known design. In order to maintain the rotational capability over a long time, said bearings have to be lubricated.

The invention is based on the object of providing a bearing element with particularly advantageous lubrication properties.

This object is achieved by the features of patent claim 1. Advantageous embodiments are described in the subclaims.

The bearing element according to the invention having rolling bodies which are arranged in the circumferential direction between an inner ring and an outer ring which is arranged concentrically with respect to the inner ring, in particular having a cage for holding the rolling bodies, has porous elements for receiving lubricant in individual ring segments along the circumferential direction.

The porous elements can be impregnated with a lubricant which is suitable in an optimum manner for the special application of the bearing (for example, with low surface tension and satisfactory flowability). The flows within the bearing element which are generated by the relative movement of the outer ring with respect to the inner ring during a rotational movement transport the lubricant into the contact region of the rolling bodies with the bearing rings.

The lubricant transport is influenced in the circumferential direction by an arrangement of the porous elements in individual ring segments. In particular, accumulation stages and release stages for the lubricant flow are produced within the bearing element by the alternating of ring segments which have porous elements and ring segments which do not have any porous elements. Overall, the lubricating action is improved as a result.

Here, the porous elements are, in particular, open-pore and gas-permeable porous elements, it being possible for the porous elements to consist of a sponge-like, absorbent material on textile or plastic basis or from metal wool, sintered material or metal foam.

In one preferred embodiment, the porous elements are distributed equidistantly over the circumference, that is to say the spacing between the individual porous elements remains identical over the entire circumference. As a result, a lubricating action can be achieved which remains constant over the circumference.

Approximately from 40% to 60% of the ring segments advantageously have porous elements along the circumferential direction. As a result, changes between ring segments with porous elements and ring segments without porous elements occur increasingly along the circumference. Correspondingly, accumulation and release stages also occur increasingly within the lubricant flow, and the lubricating action is increased.

In one advantageous embodiment, at least one radially extending outer face of the porous elements has a chamfer, in particular a chamfer which extends in the axial direction. In particular, the release of the lubricant from this radially extending outer face and/or the accumulation effect of the radially extending outer face can be influenced by said chamfer.

In a further advantageous embodiment, the porous elements have a ring segment-like basic shape with an inner circumferential face, an outer circumferential face which extends concentrically with respect to the inner circumferential face, and end faces as radially extending outer faces. Particularly simple installation into the bearing element is possible as a result.

In a further advantageous embodiment, at least one porous element has a projection which extends in the axial direction. As a result, the volume of the porous element and therefore its capacity for receiving lubricant can be increased effectively.

In a further advantageous embodiment, the bearing element is closed in the axial direction by an annular cover disk, and at least one of the porous elements is attached to the cover disk. In further embodiments, the porous elements can also be attached to the inner or outer ring and/or to the cage (rolling body cage).

In a further embodiment, the bearing element has ring segments which lie in a first plane with porous elements and ring segments which lie in a second plane, which extends parallel to the first plane and spaced apart from the latter in the axial direction, with porous elements. As a result, the number of porous elements which are present can be increased and, at the same time, the number of accumulation and release stages can be raised.

In particular, the first and the second planes can delimit the interior of the bearing element in the axial direction.

The invention is explained in further detail using exemplary embodiments in the figures of the drawing, in which:

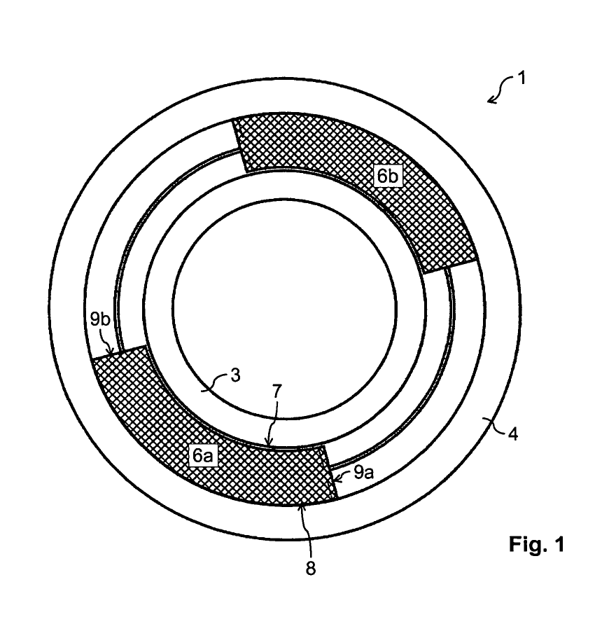

FIG. 1 shows a diagrammatic illustration of a bearing element,

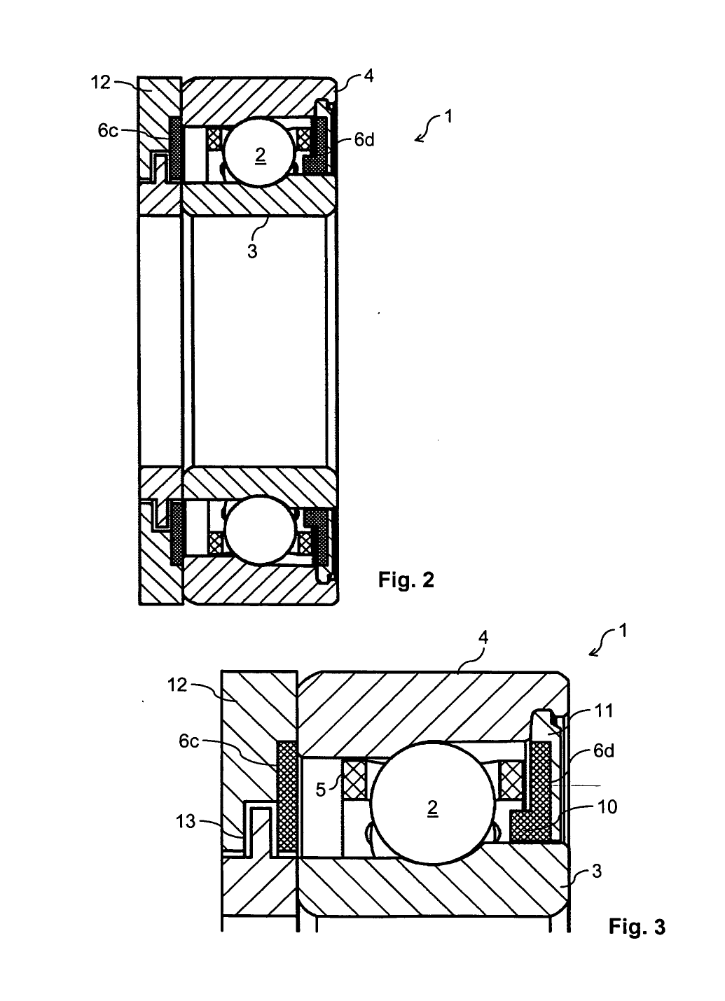

FIG. 2 shows a sectional illustration of a bearing element, and

FIG. 3 shows an enlarged detail from FIG. 2.

FIG. 1 shows an annular bearing element 1 having rolling bodies 2 (not shown in FIG. 1) which are arranged in the circumferential direction between an inner ring 3 and an outer ring 4 which is arranged concentrically with respect to the inner ring 3. The bearing element 1 has porous elements 6a and 6b for receiving lubricant in individual ring segments along the circumferential direction. The porous elements 6a and 6b have a ring segment-like basic shape with an inner circumferential face 7 and an outer circumferential face 8 which extends concentrically with respect to the inner circumferential face 8, and radially extending end faces 9a and 9b. The end face 9a has a chamfer which extends in the axial direction.

The porous elements 6a and 6b are arranged equidistantly and in each case cover a quarter of the circumference. In each case one ring segment which has the size of a quarter-circle and does not have any porous elements is present between the porous elements 6a and 6b. Overall, there are therefore porous elements in 50% of the ring segments along the circumferential direction.

FIG. 2 and FIG. 3 show a sectional illustration through a bearing element 1 and an enlarged detail from said sectional illustration. Rolling bodies 2 are held in a cage 5 between an inner ring 3 and an outer ring 4. Porous elements 6c and 6d for receiving lubricant are provided in the bearing element 1 in individual ring segments along the circumferential direction. In each case a plurality of porous elements 6c and 6d are arranged along the circumference, and ring segments which do not have any porous elements are present between the respective porous elements 6c and 6d.

Furthermore, the porous element 6d has a projection 10 which is arranged on the inner ring 3 and extends in the axial direction. The bearing element 1 is closed in the axial direction by an annular cover disk 11 and the closure lid 12, the porous element 6d being attached to the cover disk 11 and the porous element 6c being attached to the closure lid 12. Furthermore, the closure lid 12 is configured as a separate component and has a labyrinth seal 13.

Within the bearing element 1, there are ring segments which lie in a first plane with porous elements 6c and ring segments which lie in a second plane, which extends parallel to the first plane and spaced apart from the latter in the axial direction, with porous elements 6d. Here, the first and the second planes delimit the interior of the bearing element in the axial direction.

### LIST OF DESIGNATIONS

1 Bearing element
2 Rolling body
3 Inner ring
4 Outer ring
5 Cage
6a, 6b, 6c, 6d Porous element
7 Inner circumferential face
8 Outer circumferential face
9a, 9b End face
10 Projection
11 Cover disk
12 Closure lid
13 Labyrinth seal

1. A bearing element (1) having rolling bodies (2) which are arranged in the circumferential direction between an inner ring (3) and an outer ring (4) which is arranged concentrically with respect to the inner ring (3), in particular having a cage (5) for holding the rolling bodies, the bearing element (1) having porous elements (6a, 6b, 6c, 6d) for receiving lubricant in individual ring segments along the circumferential direction.

2. The bearing element (1) as claimed in claim 1, the porous elements (6a, 6b, 6c, 6d) being distributed equidistantly over the circumference.

3. The bearing element (1) as claimed in claim 1, from 40% to 60% of the ring segments having porous elements (6a, 6b, 6c, 6d) along the circumferential direction.

4. The bearing element (1) as claimed in claim 1, at least one radially extending outer face (9a) of the porous elements (6a, 6b, 6c, 6d) having a chamfer, in particular a chamfer which extends in the axial direction.

5. The bearing element (1) as claimed in claim 1, the porous elements (6a, 6b, 6c, 6d) having a ring segment-like basic shape with an inner circumferential face (7), an outer circumferential face (8) which extends concentrically with respect to the inner circumferential face (7), and end faces (9a, 9b) as radially extending outer faces.

6. The bearing element (1) as claimed in claim 1, at least one porous element (6a, 6b, 6c, 6d) having a projection (10) which extends in the axial direction.

7. The bearing element (1) as claimed in claim 1, the bearing element (1) being closed in the axial direction by an annular cover disk (11), and at least one of the porous elements (6d) being attached to the cover disk (11).

8. The bearing element (1) as claimed in claim 1, the bearing element (1) having ring segments which lie in a first plane with porous elements (6c) and ring segments which lie in a second plane, which extends parallel to the first plane and spaced apart from the latter in the axial direction, with porous elements (6d).

9. The bearing element as claimed in claim 8, the first and the second planes delimiting the interior of the bearing element (1) in the axial direction.
